(19) United States
(12) Patent Application Publication
(10) Pub. No.: US 2026/0017069 A1
(43) Pub. Date: Jan. 15, 2026

(54) SYSTEMS AND METHODS FOR GENERATING AND EXECUTING AUTOMATED WORKFLOWS

(71) Applicant: Simnang IP, LLC, Farmington, UT (US)

(72) Inventor: Rhett M. Roberts, Kaysville, UT (US)

(73) Assignee: Simnang IP, LLC, Farmington, UT (US)

(21) Appl. No.: 18/767,102

(22) Filed: Jul. 9, 2024

(51) Int. Cl. G06F 9/451; G06F 21/31

(52) U.S. Cl. CPC G06F 9/451; G06F 21/31

(57) ABSTRACT

A system may include a capacity plan engine for managing parameters of a capacity plan, an actions engine for configuring and executing automated workflows on the capacity plan, a database storing one or more action data structures defining a set of actions for the automated workflow and a sequence thereof, and a graphical user interface (GUI) to facilitate user selection of the action data structure to cause the actions engine to access the database to automatically execute the automated workflow on the capacity plan using the capacity plan engine according to the sequence defined by the one or more action data structures.

### BACKGROUND

The present disclosure relates generally to the field of automating computer operations. Managing customer accounts, such as loan accounts, includes various tasks requiring navigation through multiple systems and user interface pages.

### BRIEF DESCRIPTION OF THE DRAWINGS

FIG. 1 is a block diagram of an example environment, according to some implementations.

FIG. 2 is a block diagram of the loan management system (LMS) of FIG. 1, according to some implementations.

FIG. 3 is a diagram of an example action table, according to some implementations.

FIG. 4 is a diagram of an example workflow table, according to some implementations.

FIG. 5 is a block diagram of an example GUI, according to some implementations.

FIG. 6 is a flow diagram illustrating operations of an example method for generating an automated workflow, according to some implementations.

FIG. 7 is a flow diagram illustrating operations of an example method for generating an automated workflow, according to some implementations.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

Aspects of the present disclosure relate to generating and implementing automated workflows for servicing electronic data records, such as may be utilized to track or maintain capacity plans. The automated workflows can be generated using a workflow framework that allows users to select and configure actions to be included in the automated workflow. The automated workflow may include actions that request user input, automatically generate and/or modify data structures, and automatically coordinate actions between various computing systems (e.g., by making requests such as API requests, API calls, or sending webhooks, etc.). A user can configure the automated workflow to specify when user input is requested, how rules are applied to execute automated actions, and how interface requests (e.g., API calls, API requests, webhooks, etc.) are made to computing systems. In this way, the user has a high level of control over the generation of the automated workflow and associated data structures. However, the user does not have to write code or otherwise perform programming for the automated workflow. The user is able to specify parameters of the automated workflow within the workflow framework. This can allow for no-code creation of automated workflows for servicing the capacity plans.

While various examples of the present disclosure are directed to automated workflows for managing capacity plan (e.g., lines of credit) data structures, such as in the context of a loan management system, the same description and functionality applies to other data structures, such as loan (e.g., installment loan) data structures. Furthermore, the automated workflows discussed herein may be broadly applied to management of data records and automation of computer tasks. In an example, automated workflows as discussed herein can be applied to management of computer user accounts, allowing IT administrators to build automated workflows for configuring computer user accounts, updating user permissions, and updating software or firmware. In this example, the automated workflows can be executed in response to user input, in response to API calls, and/or in response to changes to user information. In other examples, automated workflows as discussed herein can be applied to management of other records, allowing users to build automated workflows for a variety of computing tasks involving various systems, which are potentially disparate, such as handling inventory, managing automobile records, building family trees, etc. In an example, automated workflows as discussed herein can be applied to management of genealogical records, allowing users to build automated workflows for, determining relationships between individuals, and storing historical records. In this example, the automated workflows can be executed in response to user input, in response to API calls, and/or in response to uploaded records.

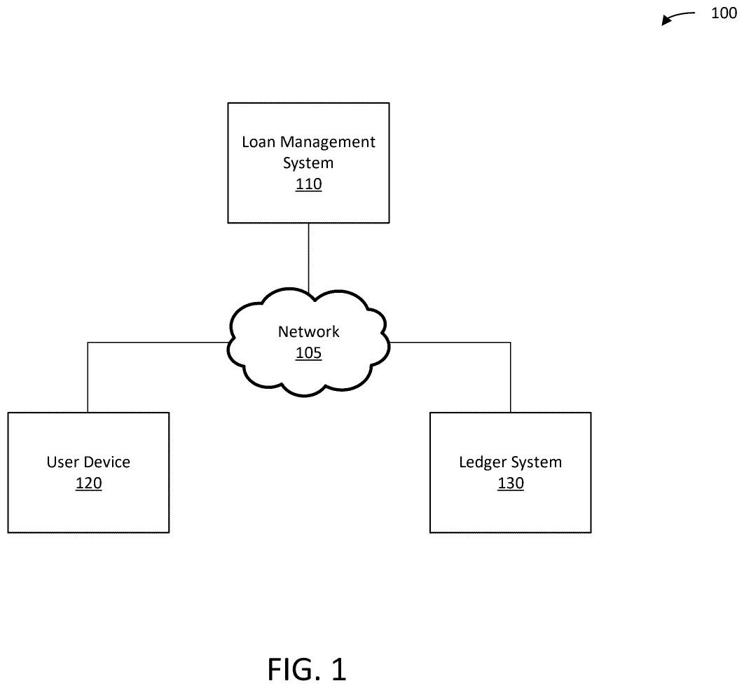

FIG. 1 is a block diagram illustrating an example environment 100, according to some implementations. The environment 100 includes a loan management system (LMS) 110, a user device 120, a ledger system 130 (e.g., a financial institution), and a network 105. The LMS 110 may provide for creation and management of a capacity plan (e.g., a line of credit (LOC)) at the ledger system 130. The LMS 110 may receive messages via the network 105 from the user device 120 regarding a capacity plan, determine one or more actions to be taken based on the received messages, and transmit messages via the network 105 to the ledger system 130 based on and/or including the received messages. The LMS 110 may send messages to various other computing systems for servicing the capacity plan. In an example, the LMS 110 makes interface requests (e.g., API calls, API requests, webhooks) to the ledger system 130 and an additional computing system to update a data structure of the capacity plan. In some implementations, a data structure of the capacity plan at the LMS 110 mirrors a data structure of the capacity plan at the ledger system 130. In some implementations, the data structure of the capacity plan at the LMS 110 includes greater detail and/or functionality than the data structure of the capacity plan at the ledger system 130. The ledger system 130 may be a financial institution maintaining one or more databases for capacity plans, loans, or accounts.

The LMS 110 may provide for automatically allocating exchanges (e.g., transactions) to categories, or buckets within a capacity plan. The LMS 110 may automatically determine, based on characteristics of an exchange, a corresponding bucket, and allocate the exchange to the bucket. The LMS 110 may define and enforce various rules for the buckets of a capacity plan, such as spending limits for the buckets, alerts based on spending within a bucket, or reporting based on spending within a bucket. The LMS 110 may associate various different credit limits with buckets of a capacity plan. The LMS 110 may allocate payments to the capacity plan to one or more buckets, based on predefined rules, user preferences, and/or user input.

In some implementations, the LMS 110 allows for creation of installment loans based on capacity plans. In an example, a capacity plan having a first interest rate may be used to generate installment loans to organize payments of a utilization of the capacity plan. In this example, the utilization of the capacity plan can be used for generating one or more installment loans equal to the utilization of the capacity plan. In some implementations, the LMS 110 creates an installment loan based on an available credit of the capacity plan. In this way, the funds are made available to users (linked to the installment loan) in an organized manner (set time for repayment, monthly payments, etc.) based on the authorization for disbursement of funds represented by the available credit of the capacity plan.

The LMS 110 may execute automated workflows for servicing the capacity plan (e.g., modifying the data structure of the capacity plan). The user device 120 may specify actions and corresponding action parameters to be included in the automated workflows. The LMS 110 may generate and/or modify one or more data structures for the automated workflows based on the input from the user device 120. The user device 120 may include multiple different computing devices. In some implementations, the user device 120 includes a computing device of an administrator of the LMS 110. In some implementations, the user device 120 includes a computing device of a borrower associated with the capacity plan. In an example, an administrator of the LMS 110 generates an automated workflow at the LMS 110 for updating a capacity plan data structure based on a borrower request to change an address. In this example, the automated workflow is executed at the LMS 110 based on a borrower requesting an address change. In this way, the LMS 110 provides for automated servicing of the capacity plan, increasing an efficiency of capacity plan operations and allowing for rapid updates to the capacity plan data structure based on borrower requests. In an example, an administrator of the LMS 110 generates an automated workflow at the LMS 110 for updating the capacity plan data structure based on a request from the ledger system 130. In this example, the ledger system 130 may make an interface request (e.g., an API call, API request, webhook, other communication) to the LMS 110 including the request, causing the automated workflow to be executed at the LMS 110 to update the capacity plan data structure. In this example, the LMS 110 makes an interface request to the ledger system 130 in response to the update to the capacity plan data structure to inform the ledger system 130 that the capacity plan data structure is updated.

The LMS 110 may send and receive messages (e.g., interface requests) via the network 105 to and from a plurality of user devices and a plurality of ledger systems. As discussed herein, the plurality of user devices can include administrator devices of the LMS 110 and borrower devices associated with capacity plans managed by the LMS 110. In this way, the LMS 110 provides a centralized system for managing capacity plans associated with a plurality of borrowers at a plurality of ledger systems.

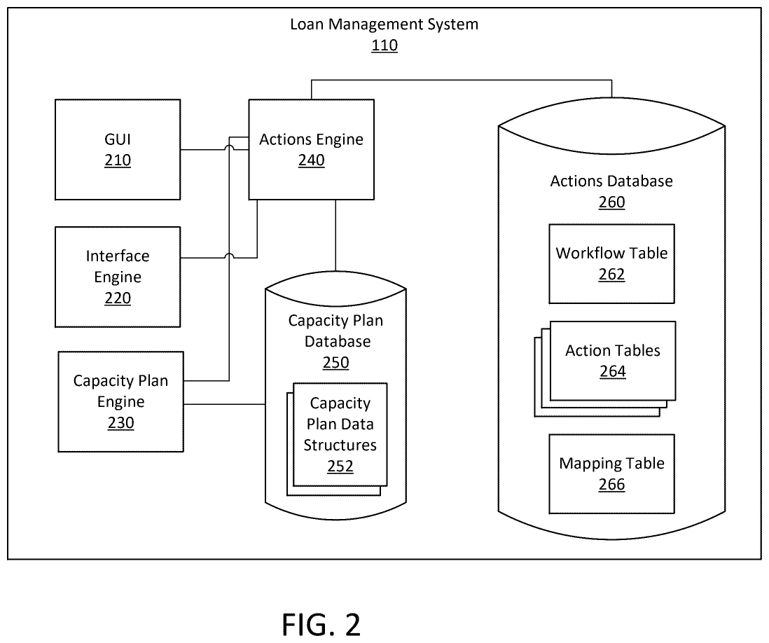

FIG. 2 is a block diagram illustrating the LMS 110 of FIG. 1, according to some implementations. The LMS 110 includes a GUI 210, an interface engine 220, a capacity plan engine 230, an actions engine 240, a capacity plan database 250, and an actions database 260.

The GUI 210 may be an interactive user interface allowing for a user to view, modify, create, and/or delete data structures corresponding to capacity plans and/or automated workflows. The GUI 210 may display elements corresponding to the data structures and corresponding parameters. The GUI 210 may display first elements corresponding to the data structures to an administrator of the LMS 110 and second elements corresponding to the data structures to a borrower or ledger system. The GUI 210 may allow the borrower or ledger system to make first changes to the data structures and the administrator of the LMS 110 to make second changes to the data structures.

The GUI 210 may provide user (e.g., administrator of the LMS 110, borrower, and/or ledger system) input to the capacity plan engine 230. The capacity plan engine 230 may implement changes to the capacity plan data structures 252. The capacity plan database 250 may store the capacity plan data structures 252. The capacity plan engine 230 may access the capacity plan database 250 to create, modify, and/or delete the capacity plan data structures 252. The capacity plan engine 230 may enforce authorization rules for creating, modifying, and/or deleting the capacity plan data structures 252. The capacity plan engine 230 may receive instructions for creating, modifying, and/or deleting the capacity plan data structures 252. The capacity plan engine 230 may receive these instructions from the GUI 210, the interface engine 220, and/or the actions engine 240.

The GUI 210 may provide user input to the actions engine 240. The actions engine 240 may provide for creating, modifying, and/or deleting automated workflow data structures. The actions engine 240 may execute the automated workflows using the automated workflow data structures. The actions engine 240 may send commands to the capacity plan credit engine 230 to execute the automated workflows. The actions engine 240 may access the capacity plan database 250 to use information of the capacity plan data structures and/or to modify the capacity plan data structures. The actions engine 240 may receive commands from the GUI 210 to execute the automated workflows. The actions engine 240 may receive commands from the interface engine 220 to execute the automated workflows. An example of the interface engine 220 is an API engine that makes API call and API requests.

The actions engine 240 may send commands to the interface engine 220 to execute the automated workflows. The interface engine 220 may receive and make interface requests to trigger and/or as part of the automated workflows. In an example, a ledger system makes an interface request to the loan management system 110 to log a payment to a capacity plan, and the interface engine 220 ingests the interface request to send a request to the actions engine 240 to execute an automated workflow to log the payment. In this example, once the payment is logged, the actions engine 240 sends a command to the interface engine 220 to send an API response to the ledger system that the payment has been logged. The interface engine 220 makes an interface request to the ledger system to inform the ledger system that the payment has been logged. The interface engine 220 may receive interface requests from a plurality of computing systems and make interface requests to a plurality of computing systems. In an example, the interface engine 220 receives an interface request from a borrower device to update an autopay setting. The interface engine 220 sends a command to the actions engine 240 to update the autopay setting, causing the actions engine to execute an automated workflow for updating the autopay setting. As part of the automated workflow, the actions engine 240 instructs the interface engine 220 to make an interface request to an email service to send an email to an email account associated with the borrower regarding the updated autopay setting and to send an API response to the borrower device regarding the updated autopay setting. In this way, the automated workflows can include actions performed by the LMS 110 as well as interface requests made to other computing systems and/or services for execution of other actions.

The automated workflows may correspond to automated workflow data structures stored in an actions database 260. The actions engine 240 may access the actions database 260 to execute the automated workflows. The automated workflows may each include actions to be performed, parameters of the actions, and a sequence in which the actions are performed. The actions database 260 includes a workflow table 262, action tables 264, and a mapping table 266. In some implementations, the workflow table 262 is a table for a type of automated workflow, with data entries (workflow IDs) in the workflow table 262 corresponding to automated workflows of the type of automated workflow. In an example, the workflow table 262 is a table for the automated workflow type of “Update Account,” with data entries (e.g., record lines) in the workflow table 262 corresponding to individual automated workflows of the “Update Account” type. In this example, the individual automated workflows correspond to different updates to an account based on different actions or actions with workflow-specific parameters. The workflow table 262 may be associated with code (e.g., computer code, scripts, etc.) for executing the automated workflow. In some implementations, the execution code is stored in the actions database 260. The actions database 260 may include a plurality of workflow tables for different types of automated workflows. Examples of automated workflows for which the actions data base 260 may include a workflow table can include “send customer communication,” “update checklist,” “log a payment,” “create autopay,” “update account settings,” “credit limit adjustment,” “interest rate adjustment,” and “change statement/due date.”

The action tables 264 may correspond to the workflow table 262, representing actions that can be added to or be part of the automated workflows of the workflow table 262. The action tables 264 can be associated with code (e.g., computer code, scripts, etc.) for executing actions. In some implementations, the action tables 264 include entries indicating which automated workflows the action tables 264 are associated with. In an example, a subset of the action tables 264 include an entry (workflow ID) corresponding to an automated workflow identifier in the workflow table 262, indicating that the actions associated with the subset of the action tables 264 are part of the automated workflow associated with the automated workflow identifier. In some implementations, the workflow table 262 includes entries indicating which action tables 264 (and corresponding actions) are part of the automated workflows associated with the workflow table 262. The action tables 264 may include parameters defining how the corresponding actions are performed within the automated workflow. In an example, the action tables 264 include data entries including identifiers of automated workflows and parameters defining how the corresponding actions are performed within the automated workflows corresponding to the identifiers.

The mapping table 266 may indicate an order of actions, or action sequence within an automated workflow. The mapping table 266 may include entries corresponding to the workflow table 262, corresponding action tables of the action tables 262, and a sequence of the actions (i.e., action sequence) to be performed as part of the automated workflow. In some implementations, the mapping table 266 includes an action sequence for an automated workflow associated with an identifier of the automated workflow. In some implementations, the mapping table 266 includes an action sequence corresponding to an action sequence identifier. The action sequence identifier may be stored in a subset of the action tables 264, the subset corresponding to actions in an automated workflow. In an example, an action table of the action tables 264 includes an identifier of an automated workflow and an identifier of an action sequence defining an order of actions in the automated workflow. In an example, an action table of the action tables 264 includes an identifier of an automated workflow and a sequence identifier of the action within the automated workflow. The actions engine 240 may reference the workflow table 262, the action tables 264, and the mapping table 266 to execute the automated workflow. The actions engine 240 may reference the workflow table 262 and/or the action tables 264 to identify code to be executed, and may reference the mapping table 266 to identify in what order to execute the code. In some implementations, storing the sequence of the actions in the automated workflow in the mapping table 266 increases a speed of execution of the automated workflow relative to storing the sequence of actions in the workflow table 262 or the action tables 264.

In an example, the actions engine 240 receives a command to execute an automated workflow and references the workflow table 262 corresponding to the automated workflow to identify code to be executed and a workflow ID corresponding to the automated workflow. The actions engine 240 references the action tables 264 to identify a set (e.g., a subset) of action tables including the workflow ID to determine actions and corresponding code to be executed as part of the automated workflow, and references the mapping table 266 to determine an order of execution of the actions and corresponding code.

In some implementations, the actions database 260 includes a library of user interface pages. The user interface pages may be presented on the GUI 210 or another user interface during execution of automated workflows. The user interface pages may correspond to the action tables 264 and/or parameters of actions corresponding to the action tables 264. In an example, an action is configured with a parameter to request user input during execution of the action, causing a user interface page for requesting the user input to be displayed during execution of the action.

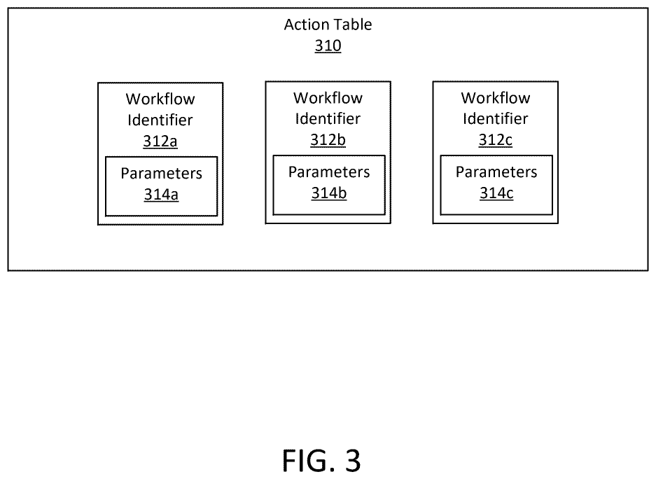

FIG. 3 is a block diagram illustrating an example action table 310, according to some implementations. The action table 310 may be an action table of the action tables 264 of FIG. 2. The action table 310 may be an example of an action table of the action tables 264 of FIG. 2 where the action tables 264 include entries identifying the workflow table with which they are associated.

The action table 310 includes a first workflow identifier 312a, a second workflow identifier 312b, and a third workflow identifier 312c (referred to collectively herein as the workflow identifiers 312) indicating that the action associated with the action table 310 is part of the automated workflows corresponding to the workflow identifiers 312, or that the code associated with the action table 310 is executed as part of the automated workflows corresponding to the workflow identifiers 312. The workflow identifiers 312 may be data entries in the action table 310. The workflow identifiers 312 may include, or be associated with parameters 314 of the action that indicate how the action is to be performed as part of the corresponding automated workflows. The parameters 314 include first parameters 314a corresponding to the first workflow identifier 312a, second parameters 314b corresponding to the second workflow identifier 312b, and third parameters 314c corresponding to the third workflow identifier 312c. The first parameters 314a, the second parameters 314b, and the third parameters 314c are referred to collectively herein as the parameters 314. In an example, the action table 310 corresponds to an action to send an email to a borrower, and the workflow identifiers 312 identify different automated workflows in which an email is sent to a borrower, with the parameters 314 specifying a content and/or format of the email for each corresponding automated workflow.

In some implementations, the workflow identifiers 312 include, or are associated with within the action table 310, action sequence identifiers defining a sequence within which the action associated with the action table 310 is performed during execution of the corresponding automated workflow. In some implementations, the workflow identifiers 312 include sequence numbers corresponding to a sequence place of the action during execution of the automated workflows. In an example, the first workflow identifier 312a is associated with a sequence number of “three,” indicating that the action associated with the action table 310 is a third action to be performed during execution of the automated workflow. In some implementations, the workflow identifiers 312 each include a full sequence of the actions to be performed during execution of the automated workflow.

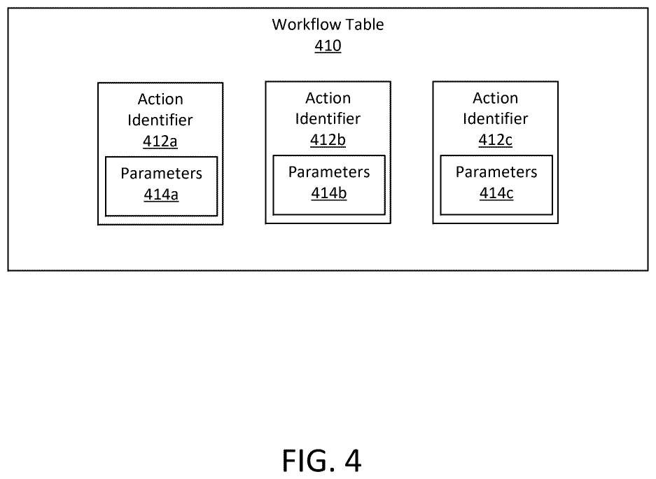

FIG. 4 is a block diagram illustrating an example workflow table 410, according to some implementations. The workflow table 410 may be an example of the workflow table 262 of FIG. 2. The workflow table 410 may be an example of the workflow table 262, where the workflow table 262 includes identifiers of actions to be performed as part of the automated workflow. In this way, the workflow table 410 represents an alternative configuration for data structures defining automated workflows. The action table 310 represents a first alternative configuration where an action table includes workflow identifiers and corresponding parameters such that workflows are included as data records in a central workflow table, with identifiers of the workflows in the action tables corresponding to actions in the workflows. The workflow table 410 represents a second alternative configuration where workflows are represented as individual data structures within which action identifiers identify the actions in the workflows.

The workflow table 410 includes a first action identifier 412a, a second action identifier 412b, and a third action identifier 412c (collectively referred to herein as action identifiers 412) corresponding to actions that are executed as part of the automated workflow of the workflow table 410. The first action identifier 412a may include or be associated with first parameters 414a indicating execution parameters for a first action corresponding to the first action identifier 412a. The second action identifier 412b may include or be associated with second parameters 414b indicating execution parameters for a second action corresponding to the second action identifier 412b. The third action identifier 412c may include or be associated with third parameters 414c indicating execution parameters for a third action corresponding to the third action identifier 412c. The first parameters 414a, the second parameters 414b, and the third parameters 414c are referred to herein collectively as the parameters 414.

The workflow table 410 may define an automated workflow and actions to be performed as part of the automated workflow. The workflow table 410 may correspond to workflow code to be executed for the automated workflow, the action identifiers 412 may correspond to action code to be executed for the automated workflow, and the parameters 414 may correspond to parameters of the action code of the automated workflow. In an example, the workflow table 410 corresponds to an automated workflow for updating an interest rate of a capacity plan, the first action identifier 412a corresponds to an interest rate update action, the second action identifier 412b corresponds to a payments calculation action, and the third identifier 412c corresponds to a send email action. In this example, when an actions engine such as the actions engine 240 of FIG. 2 executes the automated workflow, the actions engine executes the interest rate update action, the payments calculation action, and the send email action to update an interest rate of the capacity plan, calculate monthly payments for the capacity plan based on the updated interest rate, and send an email to a borrower with the updated interest rate and calculated monthly payments.

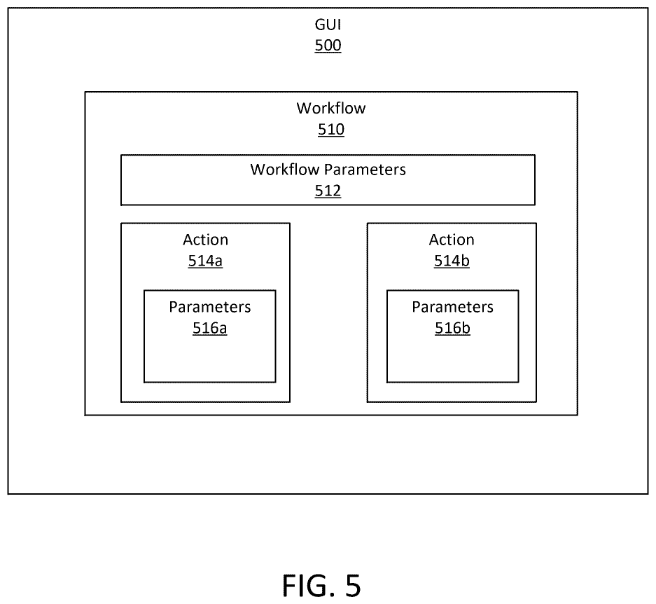

FIG. 5 is a block diagram illustrating an example GUI 500, according to some implementations. The GUI 500 may be part of or displayed on the GUI 210 of FIG. 2. The GUI 500 may be a view corresponding to an automated workflow creation process, allowing a user to create an automated workflow. The GUI 500 includes a workflow 510. The workflow 510 includes workflow parameters 512 that can be edited by the user. In an example, the workflow parameters 512 include an indication of whether user input is requested during the workflow. In an example, the workflow parameters include whether external interface requests are made during the workflow. The workflow 510 includes a first action 514a and a second action 514b. The first action 514a includes first parameters 516a that determine execution parameters of the first action 514a and the second action 514b includes second parameters 516b that determine execution parameters of the second action 514b. The GUI 500 allows the user to add, modify, and delete actions included in the workflow 510. In an example, the GUI 500 allows the user to add the first action 514a to the workflow 510 and delete the second action 514b. The GUI 500 allows the user to modify an order of the actions 514 (i.e., the first action 514a, the second action 514b, the third action 514c) by dragging and dropping the actions 514 within the workflow 510. The GUI 500 allows the user to edit the parameters 516 (i.e., the first parameters 516a, the second parameters 516b, the third parameters 516c) of the actions 514. In some implementations, the parameters 516 include an order of performance or priority of performance of the actions 514.

The order of the actions 514 in the GUI may be an indicator of an action sequence of the actions. In this way, the action sequence is visually represented in the GUI 500. In some implementations, the GUI 500 includes sequence indicators on the actions 514 that display the order of execution of the actions 514.

The parameters 516 may indicate whether the corresponding actions 514 require user input. The parameters 516 may indicate whether the user input is prompted with default values or with values corresponding to the capacity plan. In some implementations, user interface pages are retrieved from a library of user interface pages to request user input according to the parameters 516. In this way, the actions 514 are associated with the user interface pages and the user interface pages are presented during execution of the actions 514. In an example, the first action 514a is a change interest rate action and the first parameters 516a indicate that an interest rate, as populated based on capacity plan data, requires user verification for execution of the first action 514a. In an example, the second action 514b is a calculate payments action and the second parameters 516b indicate that no user input is required for execution of the second action 514b.

Once the automated workflow is created using the GUI 500, the corresponding data structures can be stored in an actions database, such as the actions database 260 of FIG. 2. As discussed herein, the automated workflow can be executed based on user input (e.g., clicking a button corresponding to the automated workflow), an interface request, and/or an update to a capacity plan. In this way, creation of the automated workflow using the GUI 500 can be used to automatically perform the actions 514 according to the parameters 516. The GUI 500 and the user input for adding actions to workflows may illustrate a conceptual or logical relationship between the automated workflow and the actions and may or may not reflect the underlying structures. In an example, the GUI 500 shows the actions 514 included within the workflow 510, illustrating the logical relationship of the actions 514 being executed as part of the workflow 510, but the underlying data structures may include adding a workflow identifier of the workflow 510 to action tables corresponding to the actions 514 in the configuration represented in FIG. 3. In an example, the GUI 500 shows the actions 514 included within the workflow 510, illustrating the logical relationship of the actions 514 being executed as part of the workflow 510, and the underlying data structures may include adding action identifiers of the actions 514 to a workflow table corresponding to the workflow 510 in the configuration represented in FIG. 4.

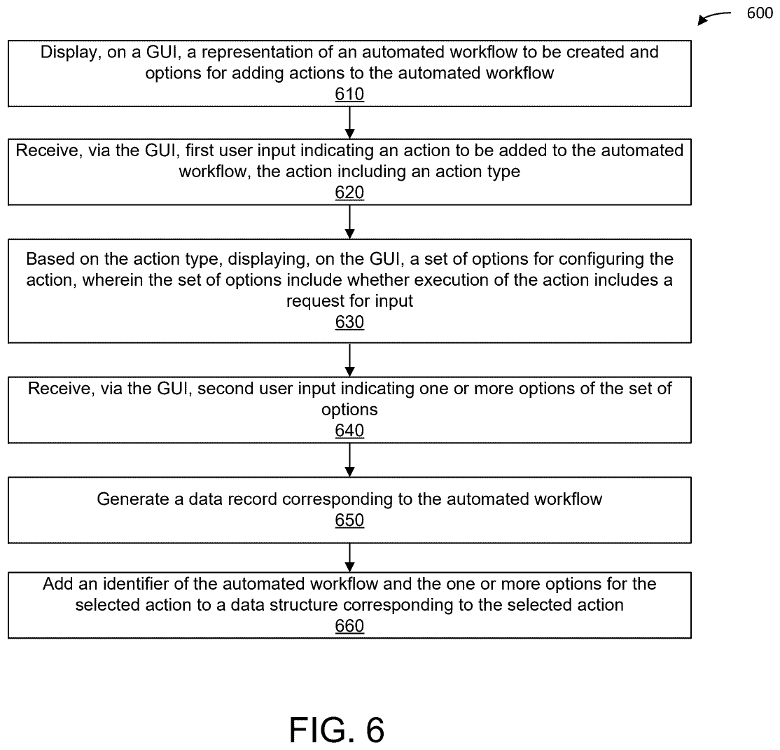

FIG. 6 is a flow diagram illustrating operations of an example method 600 for generating an automated workflow, according to some implementations. The method 600 may include more, fewer, or different operations than shown. The operations may be performed in the order shown, a different order, or concurrently. The method 600 may be performed by the LMS 110 of FIG. 2. The method 600 corresponds to the data structure configuration for automated workflows including the action table 310 of FIG. 3, where an action table includes workflow identifiers and corresponding parameters such that workflows are included as data records in a central workflow table, with identifiers of the workflows in the action tables corresponding to actions in the workflows.

At operation 610, a representation of an automated workflow to be created and options for adding actions to the automated workflow are displayed on a GUI. An example of the GUI is the GUI 500 of FIG. 5. The representation of the automated workflow data structure and options for adding actions to the automated workflow data structure may illustrate a conceptual relationship between the automated workflow and the actions and may or may not reflect the underlying structures. The options for adding the actions to the automated workflows may include action types. The options for adding the actions may define action parameters defining how the actions are performed within the automated workflow, or within an action sequence of the automated workflow. In some implementations, the option types may be displayed in response to selection of an automated workflow type. In some implementations, the types of automated workflows include different default actions to be included in the automated workflows.

At operation 620, first user input is received via the GUI, the first user input indicating an action to be added to the automated workflow, the action including an action type. In some implementations, the method 600 includes authenticating a user to allow the first user to provide the first input via the GUI. The action type may be restricted to a set of users, requiring authentication to add actions of the action type to the automated workflow. In some implementations, the action is to make an interface request to an external computing system. In response to execution of the automated workflow, the interface request is automatically made to the external computing system. The action types may include an update checklist item type, a log payment type, a create autopay type, a send customer communication type, an update account settings type, and other action types.

The update checklist item type may automatically check/uncheck one or more checklist items. A user may configure an action of the update checklist item type to determine which checklist items are checked and unchecked upon execution of the action.

The log payment type may log one or more payments to a capacity plan. A user may configure an action of the log payment type to determine fields to present to a user during the action, whether the presented fields include pre-calculated values, and whether the fields can be edited. In an example, the presented fields include an amount field including a pre-calculated value that cannot be edited, an apply date including a pre-calculated date that cannot be edited, a payment method field that can be edited, and an authorization type field that can be edited. The log payment type may include portions that are automatically performed and portions that request user input for performance. The log payment type may edit capacity plan data structures to reflect the logged payment. In an example, a first user edits the action to specify that the payment amount and payment date fields include automatically calculate values that cannot be edited and during execution of the action, a second user is unable to edit the payment amount and payment date fields, and the capacity plan data structure is automatically updated based on the payment amount and payment date during execution of the action.

The create autopay type may create and/or modify an autopay configuration for a capacity plan. A user may configure an action of the create autopay type to determine fields to present to a user during the action, whether the presented fields include pre-calculated values, and whether the fields can be edited. In an example, the presented fields include an amount field including a pre-calculated value that can be edited and an apply date including a pre-calculated date that cannot be edited. The create autopay type may log recurring payments to the capacity plan. In an example, the create autopay type may include an option to retry a payment if payment fails. In this example, during creation of the automated workflow, the action can be edited to allow a user to select the retry payment option during execution of the action. The create autopay type may include portions that are automatically performed (e.g., pre-filled fields) and portions that request user input for performance. The log payment type may edit capacity plan data structures to reflect the recurring payments. In an example, a first user edits the action to specify that the payment amount field can be edited and the payment date field includes an automatically calculated value that cannot be edited. During execution of the action, a second user is able to edit the payment amount and unable to edit the payment date field, and the capacity plan data structure is automatically updated based on the payment amount and payment date during execution of the action upon entry of the payment amount by the second user.

The send customer communication type may automatically send customer communications (e.g., emails to customers). A user may configure an action of the send customer communications type to send a communication corresponding to a set of predetermined options. In an example, the predetermined options include communications regarding logged payments, overdue payments, autopay updates, and other events. In some implementations, the send customer communication type includes making an interface request to an external email service to send an email to a customer.

The update account settings type may update account settings of an account. A user may configure an action of the update account settings type to determine fields to present to a user during the action, whether the presented fields include pre-calculated values, and whether the fields can be edited. In an example, the presented fields include an account status, an account sub-status, and autopay status, and other account settings. The update account settings type may automatically change one or more of the status parameters of the account and/or prompt a user to edit one or more of the status parameters. In an example, an action of the update account settings type can be edited to automatically populate one or more fields of the action during execution and allow a user to edit the on fields of the action during execution. The action, when executed, automatically changes account settings (i.e., edits an account data structure).

An automated workflow may include multiple action types with user-specified parameters in a user-specified order. In an example, an automated workflow for beginning a bankruptcy process includes an action of the update account settings type which updates account settings according to bankruptcy proceedings to suspend autopay changes and limit changes to the account, an action of the create autopay type to edit an autopay configuration of the account to suspend the autopay, and an action of the send customer communications type to send an email to a customer that their account has been updated to begin the bankruptcy process. In an example, an automated workflow includes an action of the log payment type to log a payment, a first action of the send customer communication type to send an email to a customer regarding the logged payment, an action of the create autopay type to configure an autopay configuration, and a second action of the send customer communication type to send an email to a customer regarding the autopay configuration.

At operation 630, based on the action type, a set of options for configuring the action are displayed on the GUI, the set of options including whether execution of the action includes a request for input. As discussed above, the set of options corresponds to the action type. The options can include whether portions of the action include a request for user input and/or whether portions of the action allow for user input.

At operation 640, second user input is received via the GUI, the second user input indicating one or more options of the set of options.

At operation 650, a data record is generated corresponding to the automated workflow. The data record may be an entry in an automated workflow table. The data record may include an identifier of the automated workflow, a description of the automated workflow, and/or a type of the automated workflow. An example of the automated workflow table is the workflow table 262 of FIG. 2. The automated workflow may be a data record (e.g., row entry in a database) in the workflow table 262. Generating the data record may allow the automated workflow to be identified in the automated workflow table and thus associated with code for executing automated workflows. However, code for executing the actions of the automated workflow may be associated with other data structures (e.g., action tables) corresponding to the actions.

At operation 660, the identifier of the automated workflow and the one or more options for the selected action are added to a data structure corresponding to the selected action. In this way, the action is associated with the automated workflow. An example of the data structure corresponding to the selected action is the action table 310 of FIG. 3. The action table may include parameters defining how the corresponding action is performed within the automated workflow. In an example, the action table includes data entries including identifiers of various automated workflows (including the identifier of the automated workflow) and parameters defining how the corresponding actions are performed within the automated workflows corresponding to the identifiers. By storing the identifier of the automated workflow in the data structure corresponding to the selected action, the automated workflow can be executed by scanning a set of actions for the identifier of the automated workflow, while the options for the selected action are stored in the data structure (e.g., action table) corresponding to the selected action. This may result in faster execution speeds relative to an architecture where a data structure of the automated workflow includes identifiers of actions within the automated workflow. Additionally, by storing the identifier of the automated workflow in the data structure corresponding to the selected action, the code associated with the selected action can be executed during execution of the automated workflow in response to identifying the identifier of the automated workflow in the data structure corresponding to the selected action. If updates to the action are needed, the code associated with the data structure corresponding to the selected action can be updated, causing execution of all automated workflows including the selected action to be updated accordingly.

The method 600 may include receiving user input to add a plurality of actions to the automated workflow. In an example, third user input is received indicating a second action to be added to the automated workflow, causing the identifier of the automated workflow to be added to a second data structure corresponding to the second action. Additional actions may be added to the automated workflow by adding the identifier of the automated workflow to data structures corresponding to the additional actions. In some implementations, user input is received indicating an order of the actions within the automated workflow. The order of the actions may determine an order of execution of the actions and/or a priority of execution of the actions. The order may be displayed on the GUI and may be manipulated by the user via the GUI (e.g., drag and drop). The order of actions may be stored in a sequence record in a sequence table, such as the mapping table 266 of FIG. 2. In an example, fourth user input is received indicating an order of the action and the second action, causing a sequence record to be generated in a sequence table, the sequence record corresponding to the order of the action and the second action.

In some implementations, the method 600 includes authenticating a user to allow the user to use the automated workflow. The method 600 may include configuring the automated workflow to require authentication of users based on user groups, user roles, and/or user identities. In some implementations, the automated workflow is configured to allow a first set of users to execute the automated workflow and modify default values presented during the automated workflow and to allow a second a second set of users to execute the automated workflow but not modify the default values. In an example, an interface call (e.g., API call) to execute an automated workflow includes authentication credentials, a token, or other authentication mechanism to cause execution of the automated workflow.

In some implementations, the method 600 includes execution of the automated workflow. Execution of the automated workflow may include displaying, one or more user interface pages corresponding to the action. In an example, the action corresponds to a user interface page in a library of user interface pages, causing the user interface page to be retrieved and displayed during execution of the automated workflow. The retrieved user interface page may be part of a user interface flow for a manual process that is performed by the automated workflow, with the retrieved user interface page used to request user input during the automated workflow. In some implementations, the user interface page is generated based on the action. Generating the user interface page may include modifying an existing user interface page based on parameters of the action.

Execution of the automated workflow may be in response to a request for the automated workflow received via the GUI, via another GUI, via an interface request, and/or from another automated workflow. In an example, a user selects a GUI element corresponding to the automated workflow to cause the automated workflow to be executed. In an example, a computing system makes an interface request to cause the automated workflow to be executed. In an example, a second automated workflow calls the automated workflow to be executed as part of execution of an action of the second automated workflow.

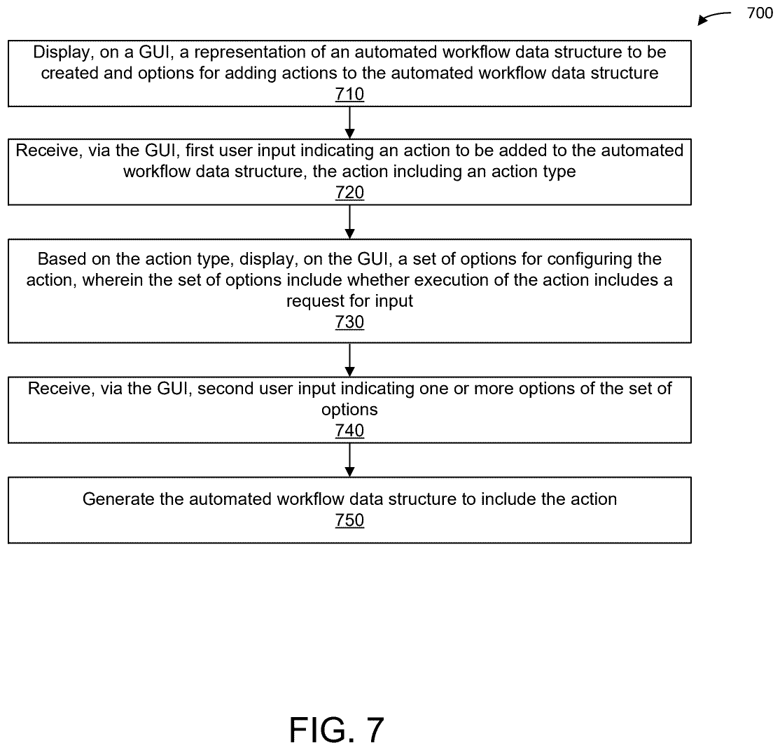

FIG. 7 is a flow diagram illustrating operations of an example method 700 for generating an automated workflow, according to some implementations. The method 700 may include more, fewer, or different operations than shown. The operations may be performed in the order shown, a different order, or concurrently. The method 700 may be performed by the LMS 110 of FIG. 2. The method 700 may be similar to the method 600, but implementing data structures such as the workflow table 410 of FIG. 4. The method 700 may be performed using the configuration of data structures corresponding to the workflow table 410 of FIG. 4. The workflow table 410 of FIG. 4 represents a configuration where workflows are represented as individual data structures within which action identifiers identify the actions in the workflows.

At operation 710, a representation of an automated workflow data structure to be created and options for adding actions to the automated workflow data structure are displayed on a GUI. An example of the GUI is the GUI 500 of FIG. 5. The representation of the automated workflow data structure and options for adding actions to the automated workflow data structure may illustrate a conceptual relationship between the automated workflow and the actions and may or may not reflect the underlying structures. The options for adding the actions to the automated workflows may include action types. The options for adding the actions may define action parameters defining how the actions are performed within the automated workflow, or within an action sequence of the automated workflow. In some implementations, the option types may be displayed in response to selection of an automated workflow type. In some implementations, the types of automated workflows include different default actions to be included in the automated workflows.

At operation 720, a first user input indication an action to be added to the automated workflow data structure is received via the GUI, the action including an action type.

At operation 730, based on the action type, a set of options for configuring the action are displayed on the GUI, the set of options including whether execution of the action includes a request for input.

At operation 740, second user input is received via the GUI indicating one or more options of the set of options. The operations 710-740 may be similar to the operations 610-640 of FIG. 6. As noted above, the GUI and interactions with the GUI may represent a conceptual, or logical relationship between automated workflows and actions and may not accurately represent the underlying data structures. The method 700 corresponds to the configuration for data structures defining automated workflows as discussed in FIG. 4. In this configuration, workflows are represented as individual data structures within which action identifiers identify the actions in the workflows.

At operation 750, the automated workflow data structure is generated to include the action. The generated automated workflow data structure may be the workflow table 410 of FIG. 4. In this way, the automated workflow data structure includes identifiers of the actions that are part of the automated workflow. The identifier of the actions may be associated, within the automated workflow data structure, with parameters for execution of the actions.

Some example implementations, according to the present disclosure, are now described.

A system may include a capacity plan engine for managing parameters of a capacity plan, an actions engine for configuring and executing automated workflows on (e.g., operations on or to) the capacity plan, a database storing one or more action data structures defining a set of actions for the automated workflow and a sequence thereof, and a graphical user interface (GUI) to facilitate user selection of the action data structure to cause the actions engine to access the database to automatically execute the automated workflow on the capacity plan using the capacity plan engine according to the sequence defined by the one or more action data structures.

In some implementations, the one or more action data structures include an action sequence table and action tables, wherein the set of actions for the capacity plan correspond to an action sequence in the action sequence table. In some implementations, a subset of the action tables include an identifier of the action sequence, the subset of the action tables defining the set of actions. In some implementations, the subset of the action tables including the identifier of the action sequence each include one or more parameters defining how the corresponding action is performed within the action sequence. In some implementations, the GUI displays an indicator of the action sequence including indicators of the set of actions. In some implementations, the GUI displays the set of actions including one or more parameters defining how the corresponding action is performed within the action sequence. In some implementations, the one or more action data structures include a mapping table defining an order of the set of actions.

In some implementations, the system includes an interface engine, wherein the actions engine automatically executes the set of actions by causing the interface engine to make an interface request to an external system. In some implementations, an action of the set of actions includes requesting user input. In some implementations, an action of the set of actions corresponds to a user interface, and wherein the actions engine accesses the database to automatically execute the automated workflow on the capacity plan by displaying the user interface on the GUI.

A method may include displaying, on a graphical user interface (GUI), a representation of an automated workflow to be created and options for adding actions to the automated workflow, receiving, via the GUI, first user input indicating an action to be added to the automated workflow, the action including an action type, based on the action type, displaying, on the GUI, a set of options for configuring the action, wherein the set of options includes whether execution of the action includes a request for input, receiving, via the GUI, second user input indicating one or more options of the set of options, generating a data record corresponding to the automated workflow, the data record including an identifier of the automated workflow, and adding the identifier of the automated workflow and the one or more options for the selected action to a data structure corresponding to the selected action.

In some implementations, the method includes authenticating a user to allow the user to use the automated workflow. In some implementations, the method includes authenticating a user to allow the user to provide the first user input indicating the action to be added to the automated workflow based on the action type being restricted to a set of users. In some implementations, the method includes receiving third user input indicating a second action to be added to the automated workflow and adding the identifier of the automated workflow a second data structure corresponding to the second action. In some implementations, the method includes receiving fourth user input indicating an order of the action and the second action and generating a sequence record in a sequence table, the sequence record corresponding to the order of the action and the second action.

In some implementations, the method includes, in response to execution of the automated workflow, displaying, on the GUI, one or more user interface pages corresponding to the action. In some implementations, the method includes retrieving the one or more user interface pages based on the action. In some implementations, the method includes generating the one or more user interface pages based on the action. In some implementations, the action comprises making an interface request to an external system, the method further comprising, in response to execution of the automated workflow, automatically making the interface request. In some implementations, the method includes receiving an interface request to execute the automated workflow.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented and/or arranged in combination in a single implementation. Conversely, various features that are described in the context of a single implementation can also be implemented and arranged in multiple implementations separately or in any suitable sub combination. Moreover, although features may be described above as acting in certain combinations and even initially claimed as such, one or more features from a claimed combination can in some cases be excised from the combination, and the claimed combination may be directed to a subcombination or variation of a subcombination.

Additionally, features described with respect to particular headings may be utilized with respect to and/or in combination with illustrative implementations described under other headings; headings, where provided, are included solely for the purpose of readability, and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims may be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Having now described some illustrative implementations, implementations, illustrative embodiments, and embodiments, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements, and features discussed only in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations, arrangements, elements, or acts of the systems and methods herein referred to in the singular may also embrace implementations including a plurality of these elements, and any references in plural to any implementation, arrangement, element, or act herein may also embrace implementations including only a single element. References in the singular or plural form are not intended to limit the presently disclosed systems or methods, or their components, acts, or elements to single or plural configurations. References to any act or element being based on any information, act, or element may include implementations where the act or element is based at least in part on any information, act, or element.

Any implementation disclosed herein may be combined with any other implementation, and references to “an implementation,” “some implementations,” “an alternate implementation,” “various implementation,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description, or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

It should be understood that no claim element herein is to be construed under the provisions of 35 U.S.C. § 112(f) unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components, including, but not limited to, processing circuitry, network interfaces, peripheral devices, input devices, output devices, and sensors. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively, or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor. In some embodiments, the one or more processors may be external to the apparatus, for example the one or more processors may be a remote processor (e.g., a cloud based processor). Alternatively, or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps, and decision steps.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

The term “coupled” and variations thereof includes the joining of two members directly or indirectly to one another. The term “electrically coupled” and variations thereof includes the joining of two members directly or indirectly to one another through conductive materials (e.g., metal or copper traces). Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical (e.g., magnetic), or fluidic.

What is claimed is:

1. A system comprising:
a capacity plan engine for managing parameters of a capacity plan;
an actions engine for configuring and executing automated workflows on the capacity plan;
a database storing one or more action data structures defining a set of actions for the automated workflow and a sequence thereof; and
a graphical user interface (GUI) to facilitate user selection of the action data structure to cause the actions engine to access the database to automatically execute the automated workflow on the capacity plan using the capacity plan engine according to the sequence defined by the one or more action data structures.

2. The system of claim 1, wherein the one or more action data structures include an action sequence table and action tables, wherein the set of actions for the capacity plan correspond to an action sequence in the action sequence table.

3. The system of claim 2, wherein a subset of the action tables include an identifier of the action sequence, the subset of the action tables defining the set of actions.

4. The system of claim 3, wherein the subset of the action tables including the identifier of the action sequence each include one or more parameters defining how the corresponding action is performed within the action sequence.

5. The system of claim 2, wherein the GUI displays an indicator of the action sequence including indicators of the set of actions.

6. The system of claim 5, wherein the GUI displays the set of actions including one or more parameters defining how the corresponding action is performed within the action sequence.

7. The system of claim 1, wherein the one or more action data structures include a mapping table defining an order of the set of actions.

8. The system of claim 1, further comprising an interface engine, wherein the actions engine automatically executes the set of actions by causing the interface engine to make an interface request to an external system.

9. The system of claim 1, wherein an action of the set of actions includes requesting user input.

10. The system of claim 1, wherein an action of the set of actions corresponds to a user interface, and wherein the actions engine accesses the database to automatically execute the automated workflow on the capacity plan by displaying the user interface on the GUI.

11. A method comprising:
displaying, on a graphical user interface (GUI), a representation of an automated workflow to be created and options for adding actions to the automated workflow;
receiving, via the GUI, first user input indicating an action to be added to the automated workflow, the action including an action type;
based on the action type, displaying, on the GUI, a set of options for configuring the action, wherein the set of options includes whether execution of the action includes a request for input;
receiving, via the GUI, second user input indicating one or more options of the set of options;
generating a data record corresponding to the automated workflow, the data record including an identifier of the automated workflow; and
adding the identifier of the automated workflow and the one or more options for the selected action to a data structure corresponding to the selected action.

12. The method of claim 11, further comprising authenticating a user to allow the user to use the automated workflow.

13. The method of claim 11, further comprising authenticating a user to allow the user to provide the first user input indicating the action to be added to the automated workflow based on the action type being restricted to a set of users.

14. The method of claim 11, further comprising:
receiving third user input indicating a second action to be added to the automated workflow; and
adding the identifier of the automated workflow a second data structure corresponding to the second action.

15. The method of claim 14, further comprising:
receiving fourth user input indicating an order of the action and the second action; and
generating a sequence record in a sequence table, the sequence record corresponding to the order of the action and the second action.

16. The method of claim 11, further comprising, in response to execution of the automated workflow, displaying, one or more user interface pages corresponding to the action.

17. The method of claim 15, further comprising retrieving the one or more user interface pages based on the action.

18. The method of claim 15, further comprising generating the one or more user interface pages based on the action.

19. The method of claim 11, wherein the action comprises making an interface request to an external system, the method further comprising, in response to execution of the automated workflow, automatically making the interface request.

20. The method of claim 11, further comprising receiving an interface request to execute the automated workflow.
